(19) United States
(12) Patent Application Publication
(10) Pub. No.: US 2026/0249386 A1
(43) Pub. Date: Aug. 27, 2026

(54) CONDUCTOR JOINING METHOD

(71) Applicant: HONDA MOTOR CO., LTD., Tokyo (JP)

(72) Inventors: Tomokatsu NISHIYAMA, Tokyo (JP); Takahiro KUBO, Tokyo (JP); Masayuki SHINTANI, Tokyo (JP); Daisuke SUDO, Tokyo (JP); Nozomu FUJITA, Tokyo (JP)

(21) Appl. No.: 19/549,291

(22) Filed: Feb. 25, 2026

(30) Foreign Application Priority Data
Feb. 27, 2025 (JP) 2025-029886

(51) Int. Cl. B23K 26/035; B23K 26/12; B23K 26/22; B23K 26/32; B23K 26/354; B23K 101/36; B23K 103/12

(52) U.S. Cl. CPC B23K 26/035; B23K 26/126; B23K 26/22; B23K 26/32; B23K 26/354; B23K 2101/36; B23K 2103/12

(57) ABSTRACT

A conductor joining method having a molten pool forming process of irradiating a welding point of conductors containing copper oxide with laser light to form a molten pool in which the welding point is melted, and a weld bead forming process of solidifying the molten pool to form a weld bead. In the molten pool forming process, laser light irradiation is performed such that, by controlling laser irradiation conditions, the welding point is heated to a temperature higher than a melting point of copper and lower than a melting point of the copper oxide to form the molten pool, and an irradiation position of the laser light is changed within the molten pool to stir the molten pool.

This application is based on and claims the benefit of priority from Japanese Patent Application No. 2025-029886, filed on 27 Feb. 2025, the content of which is incorporated herein by reference.

### BACKGROUND OF THE INVENTION

### Field of the Invention

The present invention relates to a conductor joining method.

### Related Art

In a case where conductors other than an oxygen-free copper are used as conductors included in a stator or the like of a rotating electric machine, and the conductors are welded together, there is a problem of a decrease in strength of a weld bead that is formed by welding due to hydrogen embrittlement. The primary factor of the hydrogen embrittlement of the weld bead is voids that are formed in the weld bead by bubbles of water vapor when the molten pool solidifies. The voids in the weld bead are generated when hydrogen (hydrogen ion [H⁺]) originated from moisture in the welding atmosphere as the source dissolves into the molten pool of the melted conductors, combines with oxygen (oxygen ion [O²⁻]) in the molten pool to form water (water vapor) and precipitates, in the process of the molten pool changing from a liquid phase to a solid phase and the solubility thereof decreasing. In particular, when conductors made of recycled copper or copper with low CO₂ emissions in manufacture are used as a material for the winding for the purpose of sustainable resource procurement, weld beads are prone to hydrogen embrittlement since such conductors contain copper oxide having a higher oxygen content as compared with the oxygen-free copper. Since the hydrogen-embrittled weld bead reduces the mechanical strength of a joint portion, suppression of generation of voids due to hydrogen embrittlement of the weld bead is required in order to obtain predetermined joining strength.

Conventionally, as a technology that prevents voids from being generated in a weld bead, there has been known a method that uses a laser welding apparatus that irradiates an object with laser light that contains a main power region containing a main beam, and a sub power region containing a sub-beam that has a lower power density than the main beam, and performs irradiation of the sub-beam so that voids within the molten pool escape outside the molten pool before the molten pool is solidified (for example, PCT International Publication No. WO2022/085632).

Patent Document 1: PCT International Publication No. WO2022/085632

### SUMMARY OF THE INVENTION

However, in the conventional joining method, it is necessary to perform joining by using the special laser welding apparatus capable of emitting the main beam and the sub beam that has the lower power density than the main beam, and the method is not versatile.

Furthermore, as a technology that prevents a decrease in strength of a joint portion due to generation of voids, it is also known to suppress generation of voids by adding an additive such as phosphor that reacts with oxygen or hydrogen to discharge oxygen or hydrogen as a molecule, to a molten portion, in TIG welding. However, this method requires an additive and the facility that supplies the additive to the molten portion. This method is not economical because not only the facility is complicated but also additional cost is required.

An object of the present invention is to provide a conductor joining method that can form a weld bead with generation of voids suppressed in a simple way, even with conductors that contain copper oxide.
(1) A conductor joining method includes a molten pool forming process of irradiating a welding point (for example, a welding point 310 described later) of conductors (for example, a coil end portion 31 described later) containing copper oxide with laser light (for example, laser light LB described later) to form a molten pool (for example, a molten pool 32 described later) in which the welding point is melted, and a weld bead forming process of solidifying the molten pool to form a weld bead (for example, a weld bead 33 described later). n the molten pool forming process, irradiation of the laser light is performed such that, by controlling at least one of laser output, irradiation time, and energy density, the welding point is heated to a temperature higher than a melting point of copper and lower than a melting point of the copper oxide to form the molten pool, and an irradiation position of the laser light is changed within the molten pool to stir the molten pool.

According to the above-described (1), the conductors containing copper oxide can be joined by forming the weld bead with generation of voids suppressed, by the simple method that only changes the irradiation position of the laser light to the molten pool.
(2) In the conductor joining method according to (1) described above, in the molten pool forming process, the welding point is irradiated with the laser light in an atmospheric gas-filled region.

According to the above-described (2), it is possible to reduce the amount of hydrogen that is dissolved into the molten pool from a region around the welding point.
(3) In the conductor joining method according to any one of the above-described (1) or (2), the copper oxide is tough pitch copper equivalent to JIS C1100.

According to the above-described (3), the conductors are excellent in conductivity, and the amount of oxygen contained in copper oxide is low, whereby it is possible to further suppress generation of voids in the weld bead.
(4) In the conductor joining method according to any one of the above-described (1) to (3), the laser light contains light of a near-infrared wavelength with an energy density of 33.8 kW/cm² or more and light of a visible light wavelength with an energy density of 1.41 kW/cm² or more.

According to the above-described (4), it is possible to effectively generate convection in the molten pool by the keyhole formed in the molten pool by irradiation of the laser light. Accordingly, discharge of hydrogen dissolved into the molten pool is promoted, and generation of voids in the weld bead can be further suppressed.
(5) In the conductor joining method according to any one of the above-described (1) to (4), the conductors are coils (for example, segment coils 3 described later) that protrude from a slot (for example, a slot 22 described later) of a stator core (for example, a stator core 2 described later) of a rotating electric machine.

According to the above-described (5), it is possible to manufacture the rotating electric machine including the stator in which conductor joining portions with high joining strength are formed by the simple method.

According to the present invention, it is possible to provide the conductor joining method that can form a weld bead with generation of voids suppressed in a simple way, even with conductors that contain copper oxide.

### BRIEF DESCRIPTION OF THE DRAWINGS

FIG. 1 is a schematic view showing a schematic configuration of a laser welding apparatus according to one embodiment;

FIG. 2 is a perspective view showing a plurality of coil end portions that protrude from respective slots of a stator core;

FIG. 3 is a perspective view showing an assist gas injector, and a wall member of the laser welding apparatus;

FIG. 4 is an enlarged view of part A in FIG. 1;

FIG. 5 is a vertical sectional view along line C-C in FIG. 4;

FIG. 6 is an enlarged view of part B in FIG. 1;

FIG. 7 is a vertical sectional view along line D-D in FIG. 6;

FIG. 8 is a plan view showing a state before the plurality of coil end portions are clamped by a clamping jig of the laser welding apparatus;

FIG. 9 is a plan view showing a state after the plurality of coil end portions are clamped by the clamping jig of the laser welding apparatus;

FIG. 10 is a flowchart explaining one embodiment of the conductor joining method by the laser welding apparatus;

FIG. 11 is a perspective view showing a state in which the assist gas injector, and the wall member of the laser welding apparatus are aligned with respect to the plurality of coil end portions that are objects to be laser-welded;

FIG. 12 is a plan view showing a state in which the assist gas injector, and the wall member of the laser welding apparatus are aligned with respect to the plurality of coil end portions that are objects to be laser-welded;

FIG. 13 is a vertical sectional view along line E-E in FIG. 12;

FIG. 14 is a schematic view showing a state in which a molten pool is formed at the coil end portions by irradiation of laser light;

FIG. 15 is a schematic view explaining behavior of hydrogen in the molten pool during irradiation of the laser light;

FIG. 16 is a vertical sectional view along line F-F in FIG. 12; and

FIG. 17 is a plan view showing the coil end portions where weld beads are formed.

### DETAILED DESCRIPTION OF THE INVENTION

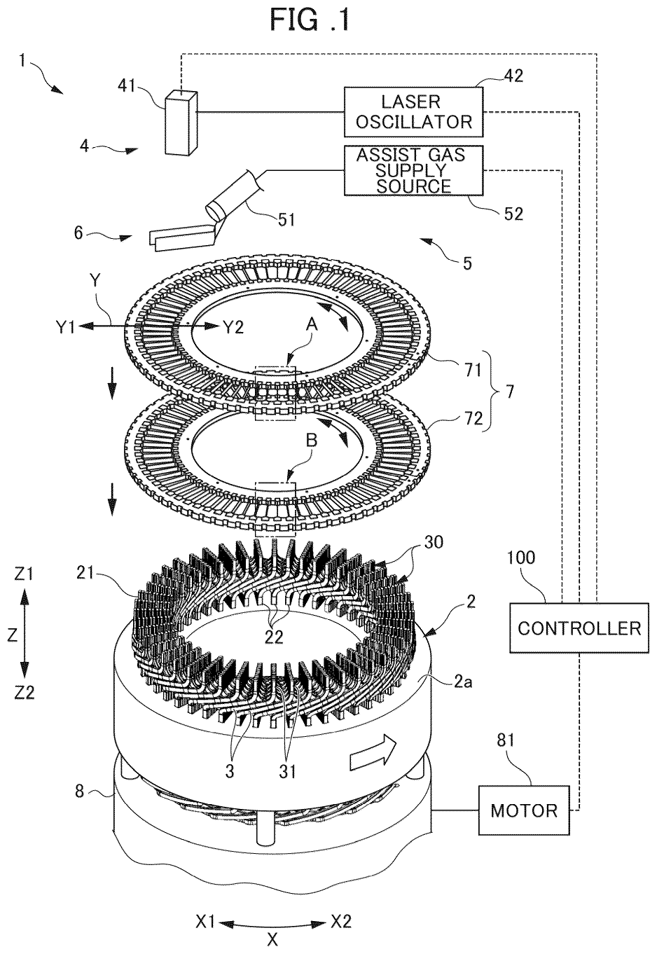

Hereinafter, an embodiment of the present invention will be described in detail with reference to the drawings. FIG. 1 schematically shows one embodiment of a laser welding apparatus that can be used when a conductor joining method according to the present embodiment is carried out. A laser welding apparatus 1 laser-welds a coil end portions 31 of a plurality of segment coils 3 that protrude from a stator core 2 that is used for a rotating electric machine (not shown). The plurality of coil end portions 31 protrude from one end surface 2a in an axial direction Z of the stator core 2.

Here, directions indicated by double-headed arrows in respective drawings will be defined. An X indicates a circumferential direction of the stator core 2. An X1 direction indicates one side in the circumferential direction X, and an X2 direction indicates the other side in the circumferential direction X. A Y indicates a radial direction of the stator core 2. A Y1 direction indicates an outer side in the radial direction Y, and a Y2 direction indicates an inner side in the radial direction Y. A Z indicates an axial direction of the stator core 2. A Z1 direction indicates one side in the axial direction Z, and a Z2 direction indicates the other side in the axial direction Z. The Z is not necessarily the direction along the vertical direction, but in the present embodiment, the case of being disposed along the vertical direction will be described. Accordingly, the Z1 direction indicates upward in the vertical direction, and the Z2 direction indicates a downward in the vertical direction.

The stator core 2 has a shaft hole 21 that is formed in an annular shape and accommodates a rotor (not illustrated) in a center so that it is rotatable. The stator core 2 has a plurality of slots 22 that are radially arranged along the circumferential direction X. The slots 22 penetrate the stator core 2 in the axial direction Z. In the respective slots 22, the plurality of segment coils 3 which are respectively electric conductors are inserted. The segment coil 3 is formed in a U-shape, and has a pair of leg portions. The pair of leg portions of the segment coil 3 are inserted into different slots 22 and 22 along the axial direction Z of the stator core 2. Accordingly, in FIG. 1, the pair of leg portions of each of the segment coils 3 protrude from the one end surface 2a of the stator core 2 which is disposed to face the upper side Z1.

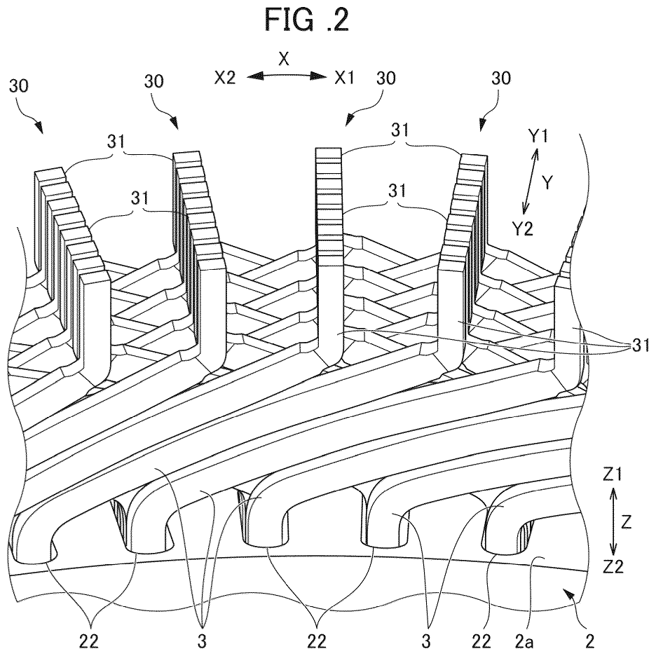

Tips of the pairs of leg portions of the respective segment coils 3 that protrude from the respective slots 22 are folded along the circumferential direction X of the stator core 2, and form the coil end portions 31. The coil end portions 31 are respectively raised substantially perpendicularly to the one end surface 2a of the stator core 2. The respective coil end portions 31 of the plurality of segment coils 3 that are inserted into the respective slots 22 are respectively arranged in one line along the radial direction Y of the stator core 2. In an example shown in FIG. 2, the eight coil end portions 31 are arranged in one line along the radial direction Y per one slot to form a coil end portion row 30 respectively. A same number of the coil end portion rows 30 as the number of the slots 22 of the stator core 2 are formed, and are radially arranged along the circumferential direction X of the stator core 2.

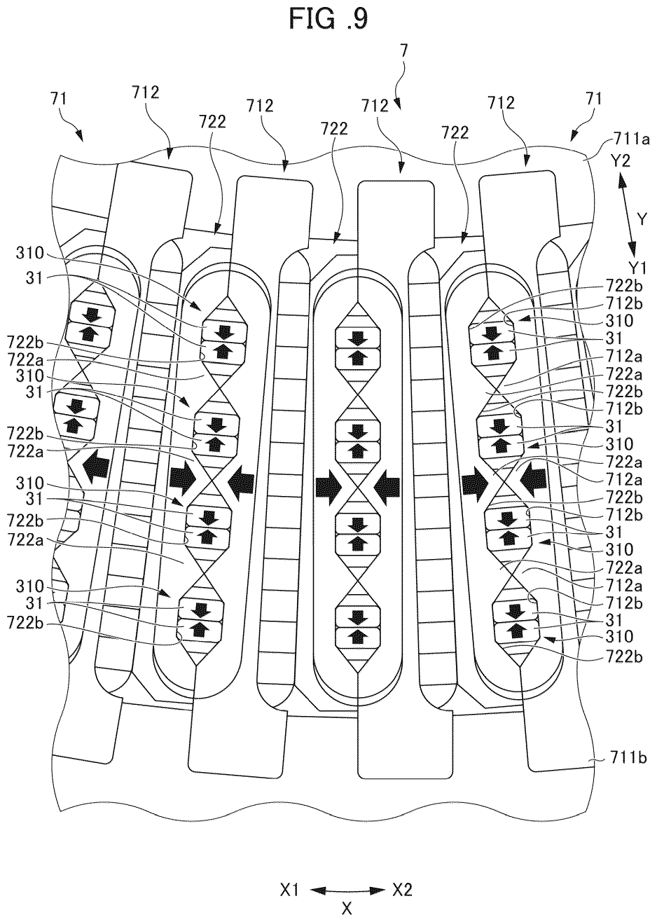

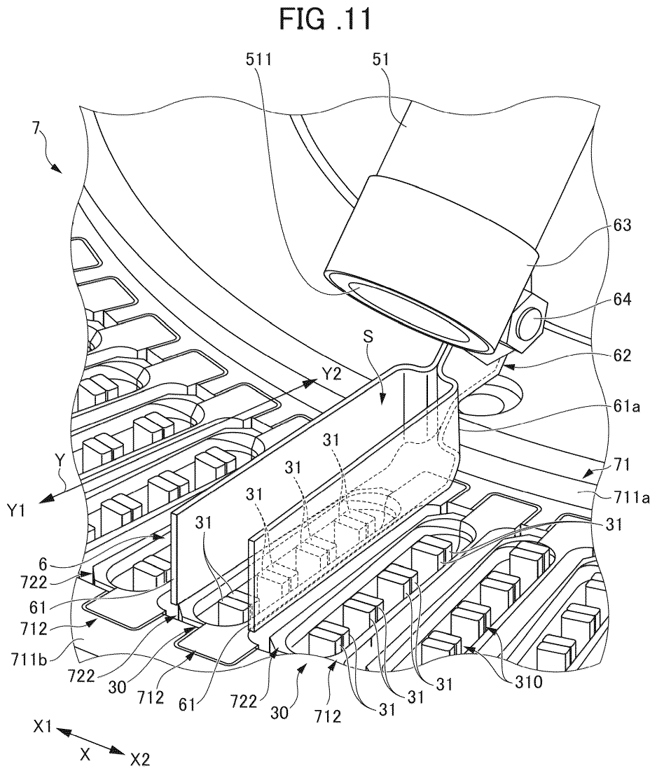

Note that a surface of the segment coil 3 is coated with an insulation coating film, but in each of the coil end portions 31, the insulation coating film is removed and a metal portion of the segment coil 3 is exposed for laser welding. Tips of the two coil end portions 31 and 31 that are adjacent along the radial direction Y in the slot 22 configure the welding point 310 (see FIG. 9 and FIG. 11). The laser welding apparatus 1 joins the coil end portions 31 and 31 by irradiating the welding point 310 with laser light.

Metal that forms the segment coil 3 contains copper oxide (I) (hereinafter simply referred to as “copper oxide”). Since recycled materials can be used for the segment coil 3, an inexpensive rotating electric machine can be constructed. The copper oxide is preferably of a quality equivalent to JIS C1100. Such copper oxide is generally called tough pitch copper and has excellent conductivity. Tough pitch copper is a eutectic of copper and copper oxide (I), and has a low oxygen content though it is copper oxide, and therefore, it is effective in suppressing voids in the weld bead. In the present embodiment, the case where tough pitch copper is used for the segment coil 3 will be described.

The laser welding apparatus 1 is configured by including a laser irradiation device 4, an assist gas injection device 5, a wall member 6, a clamping jig 7, and a fixing jig 8.

The laser irradiation device 4 is configured by having one laser irradiator 41 that irradiates the respective welding points 310 of the plurality of coil end portions 31 with laser light, and a laser oscillator 42 that generates laser light. The laser irradiation device 4 irradiates the welding points 310 each for the two coil end portions 31 and 31 that are objects to be welded with the laser light generated by the laser oscillator 42, by the laser irradiator 41.

As shown in FIG. 1, the laser irradiator 41 is disposed at the upper side Z1 of the one end surface 2a of the stator core 2. The laser irradiator 41 has an optical system that gathers laser light, and, for example, a scanner such as a galvanometer mirror that can scan and move the laser light at the welding point 310, inside. The laser oscillator 42 is not particularly limited, but it is possible to use such a laser oscillator that can generate laser light that contains, for example, light of a near-infrared wavelength (1020 nm to 1120 nm) and light of a visible light wavelength (400 nm to 500 nm). The laser irradiator 41 in this case is preferably provided so as to perform irradiation of laser light of a near-infrared wavelength, and laser light of a visible light wavelength simultaneously and coaxially. For the laser irradiation device 4 like this, for example, a fiber laser device can be used. Specifically, for example, Brace-X made by Furukawa Electric Co., Ltd., can be used.

The assist gas injection device 5 is configured by having an assist gas injector 51 having a piping structure, and an assist gas supply source 52 that generates assist gas and distributes it at a predetermined pressure to the assist gas injector 51. As shown in FIG. 1, the assist gas injector 51 is disposed between the laser irradiator 41 and the one end surface 2a of the stator core 2. The assist gas injector 51 has an injection port 511 at a tip. The assist gas injector 51 injects assist gas from the injection port 511 toward the welding points 310 of the plurality of coil end portions 31 that are objects to be welded.

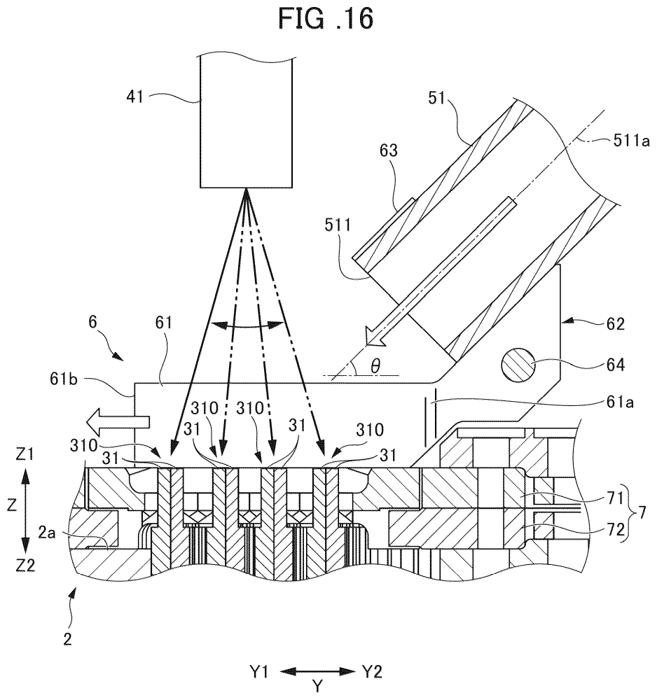

The injection port 511 of the assist gas injector 51 is disposed at one end portion side in the arranging direction of the coil end portion row 30 that includes the plurality of coil end portions 31. In detail, the injection port 511 of the assist gas injector 51 is disposed at the inner side Y2 in the radial direction Y of the stator core 2, in the coil end portion row 30, and is opened toward the outer side Y1 in the radial direction Y of the stator core 2. In more detail, the assist gas injector 51 is obliquely disposed with respect to the one end surface 2a of the stator core 2, toward the outer side Y1 in the radial direction Y from the inner side Y2 in the radial direction Y of the stator core 2 in the coil end portion row 30. That is to say, a central axis line 511a of the injection port 511 of the assist gas injector 51 is disposed so as to intersect the one end surface 2a of the stator core 2 at an angle θ that is smaller than 90° (see FIG. 16). The specific angle θ is not particularly limited, but can be, for example, 30° or more and 45° or less.

The assist gas injector 51 injects assist gas that is supplied from the assist gas supply source 52 toward the welding point 310 at predetermined pressure from the injection port 511. Accordingly, impurities such as fumes, dirt, dust, and spatter that are generated during laser welding are blown away by injection pressure of gas. The injected assist gas forms the atmospheric gas-filled region by the assist gas around the welding point 310. For the assist gas, inert gas such as argon, neon, nitrogen, and helium can be used.

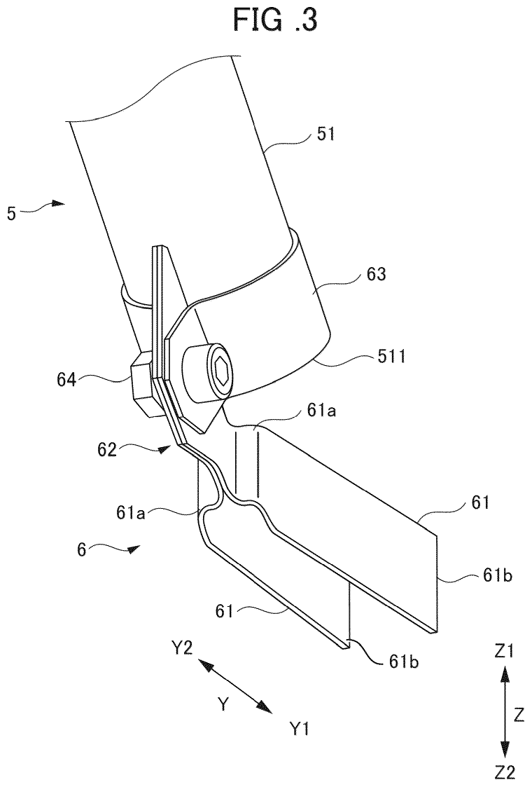

As shown in FIG. 1, the wall member 6 is disposed between the one end surface 2a of the stator core 2 and the injection port 511 of the assist gas injector 51. As shown in FIG. 3, the wall member 6 has a pair of plate portions 61 and 61. The pair of plate portions 61 and 61 are spaced at a constant interval in the circumferential direction X of the stator core 2 and extend substantially parallel along the radial direction Y of the stator core 2. Surface directions of the respective plate portions 61 and 61 are respectively along the radial direction Y of the stator core 2 and the axial direction Z of the stator core 2.

Lengths of the respective plate portions 61 and 61 along the radial direction Y of the stator core 2 are the same. The lengths of the respective plate portions 61 and 61 can be, for example, equal to or longer than a length along the radial direction Y of the coil end portion row 30 that protrudes from the slot 22. Heights of the respective plate portions 61 and 61 along the axial direction Z of the stator core 2 are constant along the radial direction Y of the stator core 2. The heights of the respective plate portions 61 and 61 can be, for example, equal to or more than a protruding height of the plurality of coil end portions 31 that protrude from the clamping jig 7 described later. The wall member 6 sandwiches the one coil end portion row 30 protruding from the stator core 2 from both sides in the circumferential direction X of the stator core 2 by the pair of plate portions 61 and 61, and accommodates a whole of the coil end portion row 30 inside. The pair of plate portions 61 and 61 that sandwich the one coil end portion row 30 forms gas regulation plates that regulate flow of the assist gas that is injected from the injection port 511, at both sides in the circumferential direction X of the one coil end portion row 30. Accordingly, it is possible to easily form the atmospheric gas-filled region by the assist gas that is injected from the injection port 511, between the pair of plate portions 61 and 61.

End portions on one side of the pair of plate portions 61 and 61 are overlapped with each other. In detail, as shown in FIG. 3, end portions 61a and 61a at the inner side Y2 in the radial direction Y of the stator core 2 in the pair of plate portions 61 and 61 are folded and overlapped with each other, and form an attachment portion 62 to the assist gas injector 51. The attachment portion 62 is fixed to an attachment pipe 63 that is attached to an outer periphery of a tip of the assist gas injector 51 by a fixing member 64 including a bolt and a nut. Accordingly, the wall member 6 is integrally attached to the tip of the assist gas injector 51.

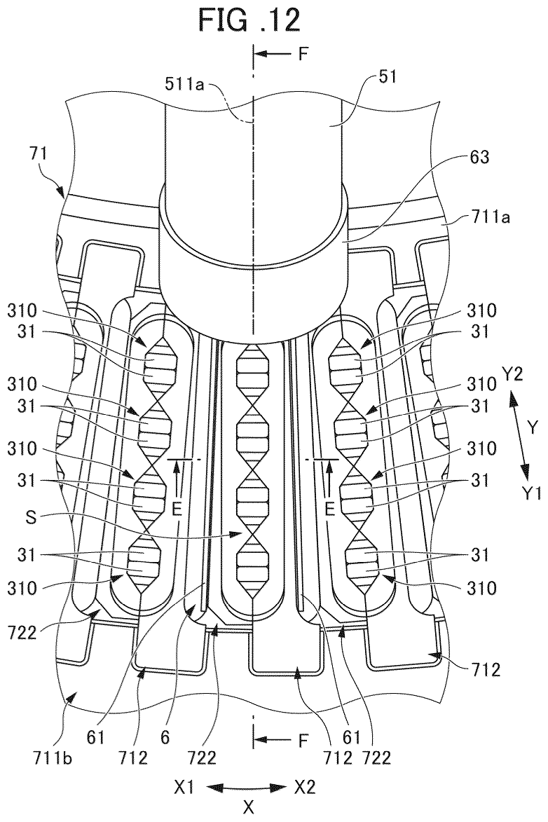

The pair of plate portions 61 and 61 of the wall member 6 extend substantially parallel to the one end surface 2a of the stator core 2 from the injection port 511 toward the outer side Y1 in the radial direction Y of the stator core 2, in a state in which they are attached to the assist gas injector 51. The extending directions of the pair of plate portions 61 and 61 are disposed to intersect the central axis line 511a of the injection port 511 of the assist gas injector 51 at the intersection angle θ (see FIG. 16). When the one end surface 2a of the stator core 2 is seen in plan view, the extending directions of the pair of plate portions 61 and 61 are disposed along the central axis line 511a of the injection port 511 of the assist gas injector 51 (see FIG. 12).

End portions 61b and 61b at the outer side Y1 in the radial direction Y of the stator core 2 in the pair of plate portions 61 and 61 of the wall member 6 are spaced apart in the circumferential direction X of the stator core 2, in a state in which a predetermined interval is maintained. As shown in FIG. 3, FIG. 11, and FIG. 12, a space between the pair of plate portions 61 and 61 is opened to the outer side Y1 in the radial direction Y of the stator core 2. Consequently, the assist gas that is injected from the injection port 511 of the assist gas injector 51 flows between the pair of plate portions 61 and 61 while being regulated by them and thereafter is smoothly discharged to the outer side Y1 in the radial direction Y of the stator core 2.

As shown in FIG. 1, the clamping jig 7 is disposed between the one end surface 2a of the stator core 2, and the wall member 6. The clamping jig 7 is configured by an upper clamping jig 71, and a lower clamping jig 72. The upper clamping jig 71 and the lower clamping jig 72 are made of plate members each in a circular ring shape having same outer diameters and same inner diameters.

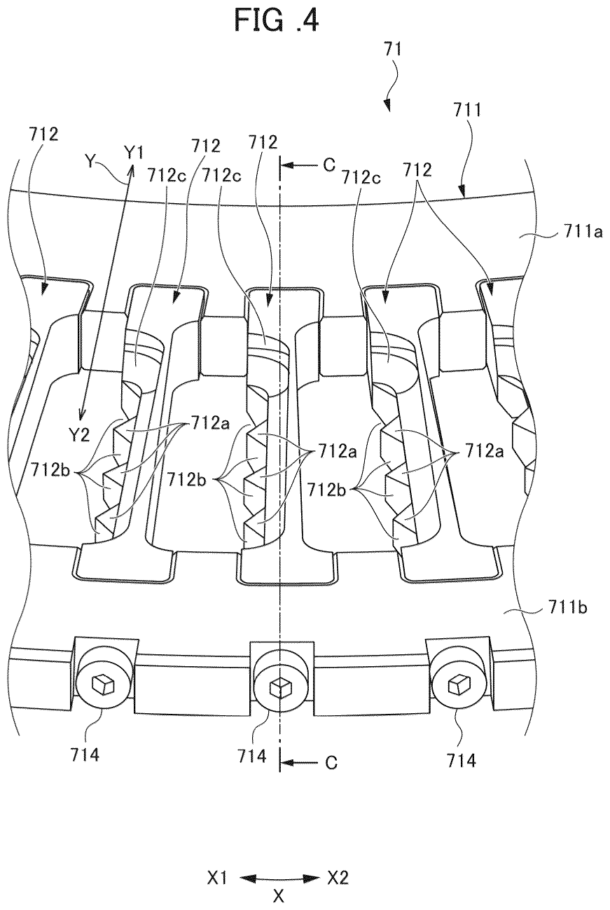

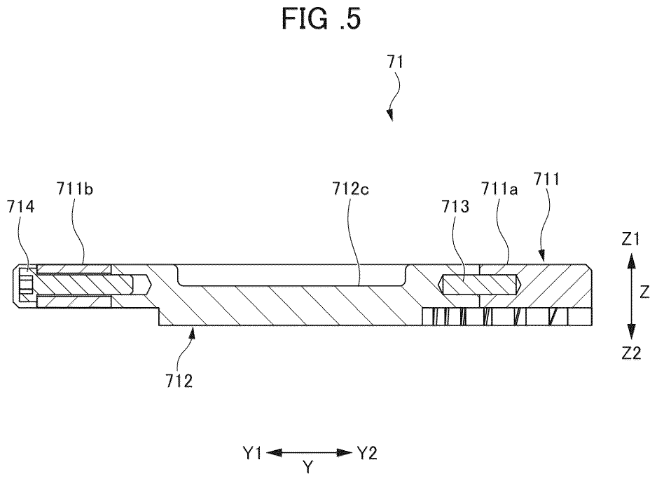

As shown in FIG. 4 and FIG. 5, the upper clamping jig 71 has an upper clamping jig body 711 in a circular ring shape. The upper clamping jig body 711 is divided into an inner peripheral annular portion 711a and an outer peripheral annular portion 711b that are each in a circular ring shape. A clamp half body 712 is provided to connect the inner peripheral annular portion 711a and the outer peripheral annular portion 711b of the upper clamping jig body 711. A same number of the clamp half bodies 712 as the number of the slots 22 of the stator core 2 (that is, the number of the coil end portion rows 30) are provided between the inner peripheral annular portion 711a and the outer peripheral annular portion 711b, and are arranged at predetermined intervals along the circumferential direction X of the upper clamping jig body 711. The clamp half body 712 is aligned with and fixed to the inner peripheral annular portion 711a by a pin 713 and is fixed to the outer peripheral annular portion 711b by a bolt 714 that is screwed from the outer side Y1 in the radial direction Y of the outer peripheral annular portion 711b.

As shown in FIG. 4, in the clamp half body 712, three guide protrusions 712a that protrude in a mountain shape are formed at the one side X1 in the circumferential direction X of the upper clamping jig 71 to be spaced at predetermined intervals in the radial direction Y of the upper clamping jig 71. Accordingly, in the clamp half body 712, four end portion accommodation recessed portions 712b each accommodating the two coil end portions 31 and 31 are formed along the radial direction Y, at the one side X1 in the circumferential direction X of the upper clamping jig 71. Note that the clamp half body 712 has a same thickness in the axial direction Z as the inner peripheral annular portion 711a and the outer peripheral annular portion 711b of the upper clamping jig body 711, and as shown in FIG. 4, in a region where the guide protrusions 712a and the end portion accommodation recessed portions 712b are formed, a recessed portion 712c having a shape that is recessed toward the one side X1 in the circumferential direction X of the upper clamping jig 71 is formed.

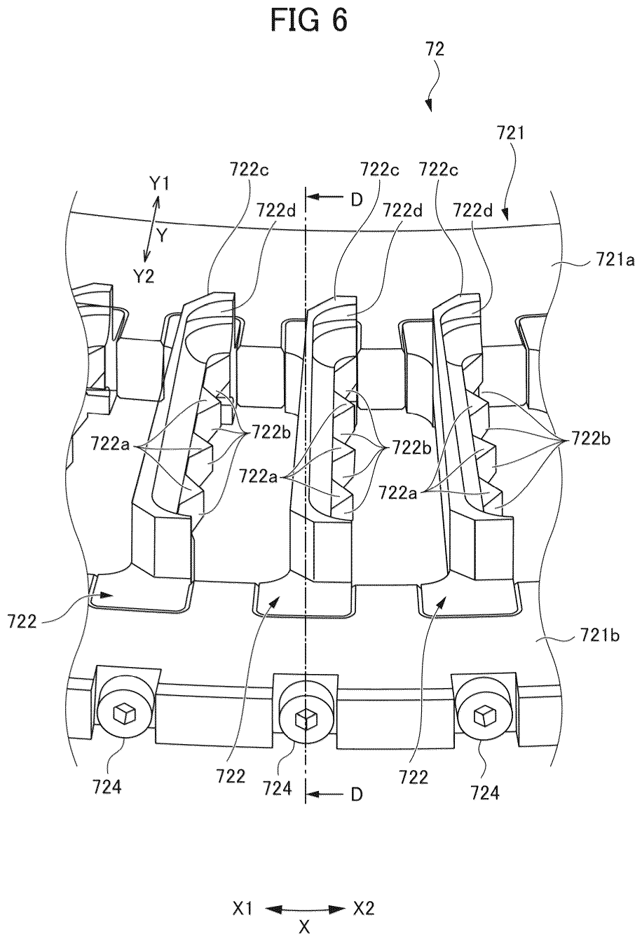

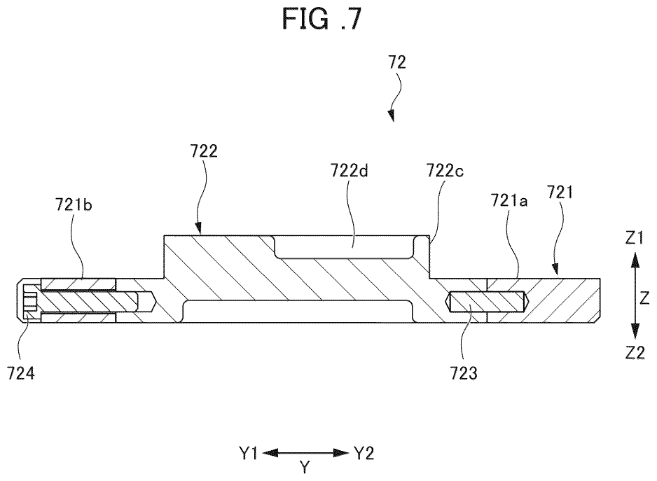

As shown in FIG. 6 and FIG. 7, the lower clamping jig 72 has a lower clamping jig body 721 in a circular ring shape. The lower clamping jig body 721 is divided into an inner peripheral annular portion 721a and an outer peripheral annular portion 721b each having a circular ring shape. A clamp half body 722 is provided to connect the inner peripheral annular portion 721a and the outer peripheral annular portion 721b of the lower clamping jig body 721. A same number of clamp half bodies 722 as the number of the slots 22 of the stator core 2 (that is, the number of the coil end portion rows 30) are provided between the inner peripheral annular portion 721a and the outer peripheral annular portion 721b, and are arranged at predetermined intervals along the circumferential direction X of the lower clamping jig body 721. The clamp half body 722 is aligned with and fixed to the inner peripheral annular portion 721a by a pin 723 and is fixed to the outer peripheral annular portion 721b by a bolt 724 that is screwed from the outer side Y1 in the radial direction Y of the outer peripheral annular portion 721b.

As shown in FIG. 6, in the clamp half body 722, three guide protrusions 722a that protrude in a mountain shape are formed at the other side X2 in the circumferential direction X of the lower clamping jig 72 to be spaced at predetermined intervals in the radial direction Y of the lower clamping jig 72. Accordingly, in the clamp half body 722, four end portion accommodation recessed portions 722b each accommodating the two coil end portions 31 and 31 are formed along the radial direction Y, at the other side X2 in the circumferential direction X of the lower clamping jig 72. Note that both end portions in the radial direction Y of the clamp half body 722 have a same thickness in the axial direction Z as the inner peripheral annular portion 721a and the outer peripheral annular portion 721b of the lower clamping jig body 721, and as shown in FIG. 6 and FIG. 7, in a region where the guide protrusions 722a and the end portion accommodation recessed portions 722b are formed, a protrusion wall portion 722c that protrudes toward the upper side Z1 is formed. The protrusion wall portion 722c is disposed at the one side X1 in the circumferential direction X in the clamp half body 722, and forms a recessed portion 722d having a shape that is recessed toward the other side X2 in the circumferential direction X.

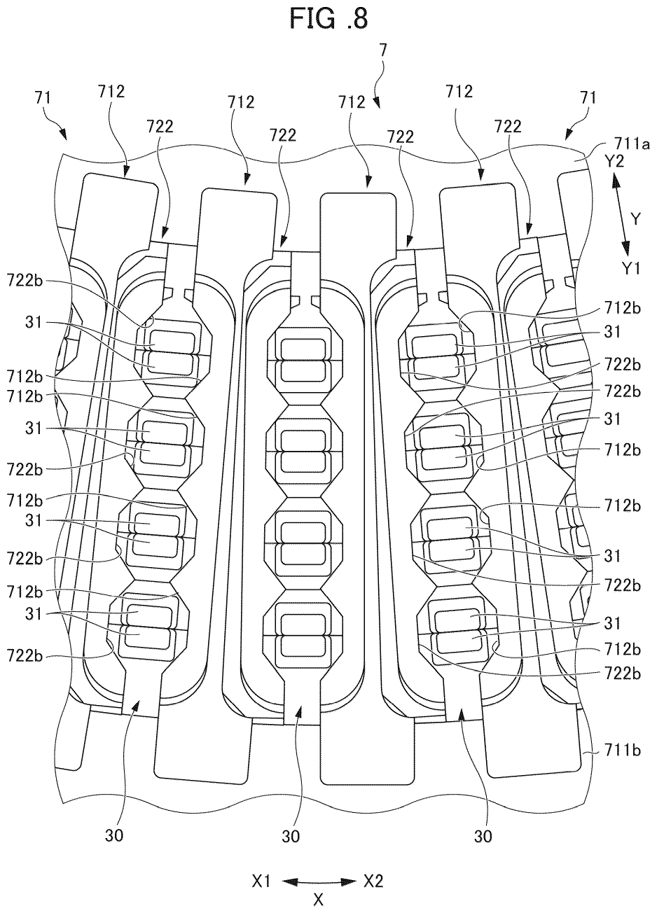

The upper clamping jig 71 and the lower clamping jig 72 are stacked so that the upper clamping jig 71 is disposed at the upper side Z1 in the axial direction Z to construct the clamping jig 7. The respective clamp half bodies 722 of the lower clamping jig 72 are each accommodated between the clamp half bodies 712 and 712 that are adjacent in the circumferential direction X of the upper clamping jig 71. As shown in FIG. 8 and FIG. 9, the guide protrusion 712a and the end portion accommodation recessed portion 712b of the clamp half body 712 of the upper clamping jig 71, and the guide protrusion 722a and the end portion accommodation recessed portion 722b of the clamp half body 722 of the lower clamping jig 72 are disposed to face each other.

The clamping jig 7 is disposed so as to approach the one end surface 2a of the stator core 2 by a moving mechanism not illustrated during laser welding. Accordingly, as shown in FIG. 8, the respective coil end portion rows 30 that protrude from the stator core 2 are respectively accommodated between the clamp half bodies 712 and 722 of the clamping jig 7. The coil end portion row 30 each including the eight coil end portions 31 is disposed between the pair of the clamp half bodies 712 and 722. The eight coil end portions 31 of the coil end portion row 30 are arranged in pairs of the two adjacent coil end portions 31 and 31, and are respectively accommodated between the four end portion accommodation recessed portions 712b of the clamp half body 712 of the upper clamping jig 71, and the four end portion accommodation recessed portions 722b of the clamp half body 722 of the lower clamping jig 72. Upper end surfaces of the eight coil end portions 31 between the end portion accommodation recessed portions 712b and 722b are disposed to be substantially flush with upper surfaces of the upper clamping jig 71 and the lower clamping jig 72.

At least one of the upper clamping jig 71 and the lower clamping jig 72 is connected to a rotating mechanism not illustrated. The rotating mechanism rotates at least one of the upper clamping jig 71 and the lower clamping jig 72 along the circumferential direction X. Specifically, when only the upper clamping jig 71 is connected to the rotating mechanism, the upper clamping jig 71 rotates to the one side X1 in the circumferential direction X with respect to the lower clamping jig 72 immobile in position. When only the lower clamping jig 72 is connected to the rotating mechanism, the lower clamping jig 72 rotates to the other side X2 in the circumferential direction X with respect to the upper clamping jig 71 immobile in position. When the upper clamping jig 71 and the lower clamping jig 72 are connected to the rotating mechanism, the upper clamping jig 71 rotates to the one side X1 in the circumferential direction X, and the lower clamping jig 72 rotates to the other side X2 in the circumferential direction X. Accordingly, the clamp half body 712 of the upper clamping jig 71 and the clamp half body 722 of the lower clamping jig 72 approach each other, and clamp the two coil end portions 31 and 31 that are disposed between the end portion accommodation recessed portions 712b and 722b from both sides in the circumferential direction X, as shown in FIG. 9. The two coil end portions 31 and 31 that are clamped are brought into close contact with each other in the circumferential direction X by being guided by inclined surfaces of the guide protrusions 712a and 722a to form the welding point 310, and brought into a laser welding standby state.

As shown in FIG. 1, the fixing jig 8 is disposed at the lower side Z2 in the axial direction Z of the stator core 2, and fixes and supports the stator core 2 with the stator core 2 placed thereon. The fixing jig 8 rotates at predetermined pitches (for example, arrangement pitches of the slots 22) around a central axis of the stator core 2 by drive of a motor 81. Accordingly, the fixing jig 8 rotationally moves the stator core 2 that is fixed and supported by the fixing jig 8 along the circumferential direction X. In this case, the fixing jig 8 and the motor 81 configure a moving device that relatively moves the stator core 2 with respect to the laser irradiator 41, the assist gas injector 51, and the wall member 6.

As shown in FIG. 1, the laser welding apparatus 1 has a controller 100. The controller 100 is electrically connected to the laser irradiator 41 and the laser oscillator 42 of the laser irradiation device 4, the assist gas supply source 52 of the assist gas injection device 5, the moving mechanism and the rotating mechanism of the clamping jig 7, and the motor 81, respectively, and by controlling operations thereof, performs laser welding to the respective welding points 310 each including the two coil end portions 31 and 31. The controller 100 operates according to a predetermined program for carrying out laser welding. The controller 100 includes a memory that stores programs and a processor. The processor controls drive of the laser oscillator 42, the assist gas supply source 52, the moving mechanism and the rotating mechanism of the clamping jig 7, and the motor 81 respectively, according to a predetermined program for laser welding that is read from the memory. The controller 100 may be provided exclusively for the laser welding apparatus 1. Furthermore, a function of the controller 100 may be realized by PC (personal computer) that is connected to the laser welding apparatus 1, or an external terminal such as a tablet terminal.

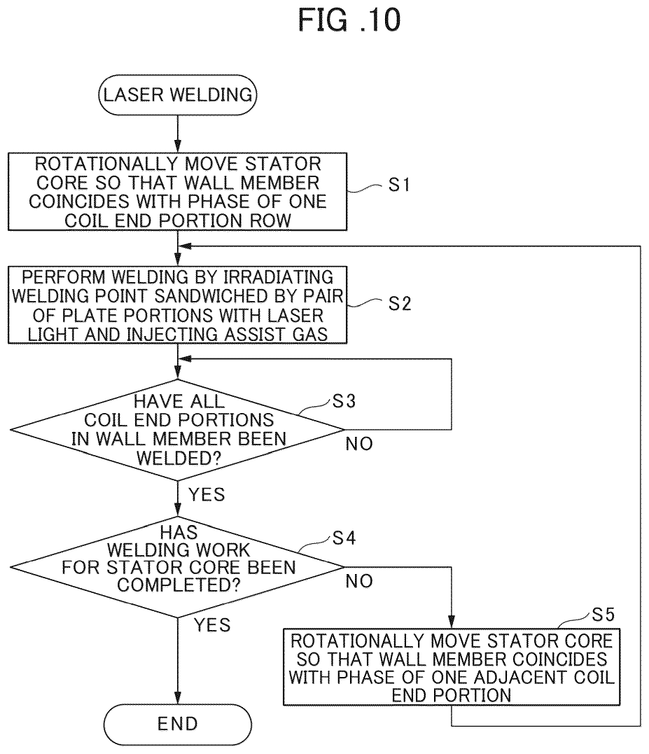

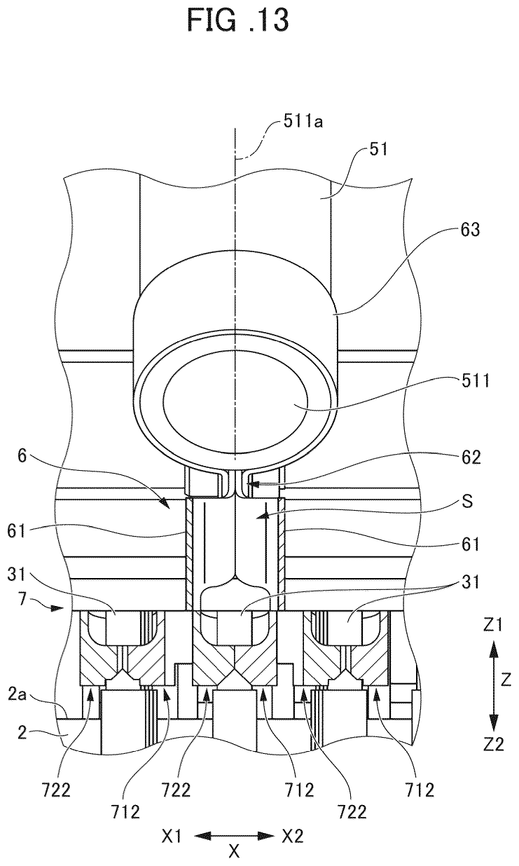

Next, the conductor joining method for joining the welding point 310 by the laser welding apparatus 1 will be described with reference to FIG. 10 to FIG. 17. FIG. 10 is a flowchart of laser welding that is carried out by control of the controller 100.

In the laser welding apparatus 1 in the laser welding standby state, the assist gas injector 51 and the wall member 6 are disposed above the clamping jig 7. The clamp half bodies 712 and 722 of the clamping jig 7 clamp the coil end portions 31. The wall member 6 is disposed to be in contact with or in close vicinity to the surface of the clamping jig 7. In this laser welding standby state, the controller 100 rotationally moves the fixing jig 8 by drive of the motor 81 to rotationally move the stator core 2 around the central axis so that the position of the wall member 6 coincides with a phase of the one coil end portion row 30 including the plurality of coil end portions 31 that are the objects to be welded in the stator core 2, and stops the stator core 2 at a predetermined rotation position (step S1).

At this time, as shown in FIG. 11 to FIG. 13, the wall member 6 is disposed to accommodate the one coil end portion row 30 between the pair of plate portions 61 and 61, and clamps an upper space S of the eight coil end portions 31 from both side in the circumferential direction X of the stator core 2 by the pair of plate portions 61 and 61. The laser radiator 41 is disposed above the wall member 6, that is, above the coil end portion row 30. The assist gas injector 51 integrated with the wall member 6 is disposed at the inner side Y2 in the radial direction Y of the stator core 2 with respect to the coil end portion row 30 and has the injection port 511 directed toward the coil end portion row 30.

Next, the controller 100 drives the laser oscillator 42 and the assist gas supply source 52, irradiates the welding point 310 at the tips of the two coil end portions 31 and 31 in the slot 22 sandwiched by the pair of plate portions 61 and 61 with the laser light LB, and injects assist gas from the injection port 511 of the assist gas injector 51 to carry out welding (step S2).

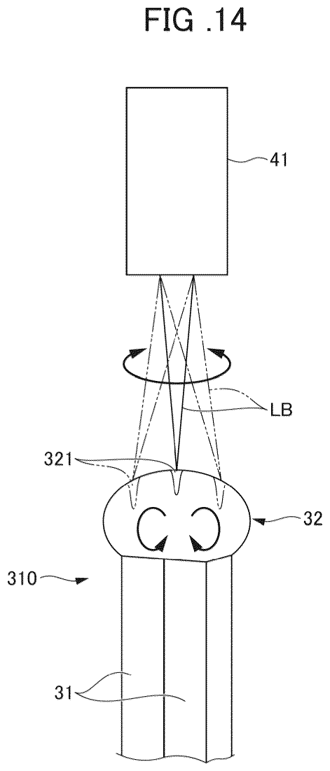

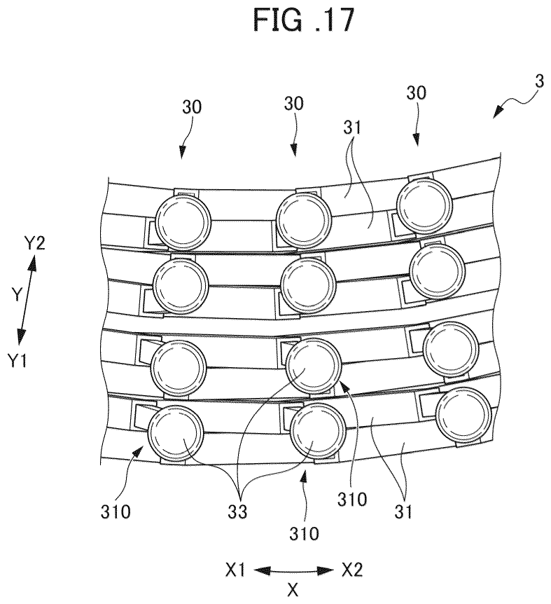

A process of carrying out welding by irradiating the welding point 310 with the laser light LB mainly includes two processes that are a molten pool forming process, and a weld bead forming process. The molten pool forming process is a process of irradiating the welding point 310 with the laser light LB, and forming the molten pool 32 as shown in FIG. 14. The weld bead forming process is a process of finishing irradiation of the laser light LB, forming the weld bead 33 in a substantially spherical shape on the welding point 310 by the solidified molten pool 32, and finishing joining the welding point 310, as shown in FIG. 17. More details of the respective processes will be explained later.

In step S2, the laser irradiator 41 scans and moves the laser light LB over the welding point 310 including the two coil end portions 31 and 31 in pair by the scanner that is controlled by the controller 100, and sequentially welds the two coil end portions 31 and 31, as shown in FIG. 16. At the same time, the assist gas injection device 5 injects assist gas at predetermined injection pressure from the injection port 511.

The assist gas that is injected from the injection port 511 through the assist gas injector 51 flows in between the pair of plate portions 61 and 61 of the wall member 6, and forms the atmospheric gas-filled region including the assist gas around the welding point 310, as shown by a white arrow in FIG. 16. Furthermore, the assist gas that flows in between the pair of plate portions 61 and 61 flows toward the outer side Y1 in the radial direction Y of the stator core 2 while blowing out impurities such as fume, dirt, dust, and spatter that are generated during laser welding, and is discharged from between the pair of plate portions 61 and 61. The wall member 6 regulates flow of the assist gas in the circumferential direction X of the stator core 2 by the pair of plate portions 61 and 61. Consequently, the impurities that are blown out are quickly discharged to the outer side Y1 in the radial direction Y of the stator core 2, and the risk of the impurities adhering to the coil end portions 31 of the other coil end portion rows 30 that are not the objects to be welded is reduced.

Note that the interval between the pair of plate portions 61 and 61 of the wall member 6 is larger than an opening diameter of the injection port 511 of the assist gas injector 51. Consequently, the atmospheric gas-filled region by the assist gas also extends around the wall member 6. Since the assist gas immediately after being injected from the injection port 511 is in a laminar flow state, the assist gas that flows on both sides of the pair of plate portions 61 and 61 does not affect blowing-away of the impurities.

Irradiation of the laser light LB and injection of the assist gas are continued until laser welding to all the coil end portions 31 in the one coil end portion row 30 in the wall member 6 is completed (step S3). That is to say, the molten pool forming process, and the weld bead forming process are carried out, for each of the four welding points 310 in the wall member 6, and finally, the weld beads 33 are formed at the welding points 310 as shown in FIG. 17. When laser welding to all the welding points 310 in the wall member 6 is completed (step S3; YES), the controller 100 determines whether or not welding operation of all the welding points 310 to the stator core 2 is completed (step S4). Whether or not the welding operation is completed is determined by, for example, the controller 100 detecting a rotation angle, the number of rotations of rotational movement and the like of the stator core 2.

When the welding operation of all the welding points 310 to the stator core 2 is not completed (step S4; NO), the controller 100 rotationally moves the stator core 2 around the central axis so that the position of the wall member 6 coincides with a phase of the one adjacent coil end portion row 30 in the stator core 2 (step S5). Thereafter, the controller 100 repeats the processes from the above-described step S2, and when the controller 100 determines that the welding operation of all the welding points 310 to the stator core 2 is completed, it ends laser welding to the stator core 2.

Next, the molten pool forming process, and the weld bead forming process during laser welding in the above-described step S2 will be described.

First, in the molten pool forming process, as shown in FIG. 14, the welding point 310 is irradiated with the laser light LB from the laser irradiator 41, and metal of the two coil end portions 31 and 31 of the welding point 310 is melted to form the molten pool 32 formed of the molten metal at the welding point 310. Note that in the present embodiment, laser welding by the laser welding apparatus 1 is executed under an environment with a temperature of 45° C. and a relative humidity of 100%.

Since the segment coil 3 contains copper oxide (I), the molten pool 32 inevitably contains oxygen (oxygen ion [O²⁻]) dissociated from copper oxide (I). This oxygen (oxygen ion [O²⁻]) and hydrogen (hydrogen ion [H⁺]) contained in moisture in the atmosphere combine, and thereby water (water vapor) that is a cause of hydrogen embrittlement of the weld bead 33 is generated. Accordingly, in order to suppress hydrogen embrittlement of the weld bead 33, in the molten pool forming process, it is important to execute at least either one, and preferably both of an approach that minimizes dissolution of hydrogen (hydrogen ion [H⁺]) into the molten pool 32 (Hereinafter, referred to as an IN side approach.), and an approach that maximizes discharge of hydrogen (hydrogen ion [H⁺]) dissolved in the molten pool 32 from the molten pool 32 (Hereinafter, referred to as an OUT side approach.).

Amounts of oxygen and hydrogen dissolved in the molten pool 32 are proportional to a temperature of the molten pool 32. The higher the temperature of the molten pool 32, the larger the dissolution amounts of oxygen and hydrogen. Accordingly, as the IN side approach, in order to reduce the dissolution amount of hydrogen (hydrogen ion [H⁺]) into the molten pool 32, it can be said as desirable that the temperature of the welding point 310 when forming the molten pool 32 is low, but a melting point of the copper oxide (I) is 1235° C., and in order to completely melt the copper oxide (I), the welding point 310 needs to be heated to a temperature of 1235° C. or higher. However, in general, even if it is the copper oxide (I), most of it is copper, and therefore, it will start to melt once it exceeds 1085° C. which is the melting point of copper. The molten pool 32 in an early stage of melting is in a state in which the copper oxide (I) in a solid phase state (unmelted state) floats in copper in a liquid phase state.

Thus, one measure of the IN side approach is that, in the molten pool forming process, the laser irradiation device 4 has the output of the laser light LB adjusted so that the welding point 310 has a temperature higher than the melting point of copper and lower than the melting point of copper oxide (I). Specifically, in the laser irradiation device 4, at least one of output power, irradiation duration, and energy density of the laser light LB is adjusted such that the welding point 310 is heated to a temperature of 1100° C. or higher which is higher than the melting point of copper, and 1200° C. or lower which is lower than the melting point of copper oxide (I). By setting the temperature when melting the welding point 310 in this manner, the dissolution amount of hydrogen (hydrogen ion [H⁺]) into the molten pool 32 is reduced.

Furthermore, an amount of oxygen contained in the winding itself of the tough pitch copper quality is approximately 500 ppm or less, and hydrogen (hydrogen ion [H⁺]) that can be dissolved into the molten bead containing the copper oxygen (I) is 1.8 ppm. That is to say, if 1.8 ppm or more of hydrogen (hydrogen ion [H⁺]) is dissolved during melting of the copper oxide (I), water (water vapor) is easily generated. Consequently, another measure of the IN side approach is to inject assist gas toward the inside of the wall member 6 from the injection port 511 of the assist gas injector 51 in the molten pool forming process, and make a region around the welding point 310 the atmospheric gas-filled region including the assist gas. Accordingly, the moisture amount around the welding point 310 is reduced to reduce the hydrogen concentration, and therefore hydrogen (hydrogen ion [H⁺]) dissolved into the molten pool 32 from the region around it is reduced. Since the welding point 310 is sandwiched between the pair of plate portions 61 and 61 of the wall member 6, it is possible not only to blow out the impurities as described above but also to easily and stably form the atmospheric gas-filled region by the assist gas around the welding point 310, by continuously injecting the assist gas during irradiation of the laser light LB. The laser irradiation device 4 forms the molten pool 32 by irradiating the welding point 310 with the laser light LB in the atmospheric gas-filled region.

In the molten pool forming process, the atmospheric gas-filled region is sealed with the assist gas by injection of the assist gas. An assist gas concentration around the welding point 310 becomes relatively high with respect to the atmosphere (air), whereby the oxygen concentration is reduced, and the dissolution amount of hydrogen (hydrogen ion [H⁺]) into the molten pool 32 can be further reduced.

The OUT side approach is to diffuse hydrogen (hydrogen ion [H⁺]) dissolved into the molten pool 32 around the molten pool 32 and discharge it. Thus, as one measure of the OUT side approach, in the molten pool forming process, the laser welding apparatus 1 drives the scanner such as the galvanometer mirror in the laser irradiator 41, scans and moves the laser light LB to change the irradiation position of the laser light LB to the molten pool 32 during formation of the molten pool 32, and stir the molten pool 32, as shown in FIG. 14. In detail, in the molten pool 32 in a liquid phase state, keyholes 321 are formed in the irradiated portions by thermal energy of the laser light LB. The keyholes 321 are cavities caused by depressions in a metal surface. The keyholes 321 remain during irradiation of the laser light LB due to a balance of metal vapor pressure, and contraction pressure caused by surface tension of the molten portions, and move in the molten pool 32 with scanning and moving of the laser light LB. Accordingly, convection occurs in the molten pool 32, and the molten metal in the molten pool 32 is stirred. Scanning and moving of the laser light LB may be repetitive linear movement with respect to the molten pool 32, or may be movement that draws a plurality of circles with respect to the molten pool 32. The irradiation position of the laser light LB may be moved in a reciprocating linear path, a circular path, or a combination thereof within the molten pool 32.

The conditions for forming the keyhole 321 in the molten pool 32 can be obtained from energy (A) for generating metal vapor pressure in the keyhole 321, energy (B) for melting copper in a wall surface of the keyhole 321, energy (C) for transmitting heat from a molten portion to a solid portion, and energy absorption rate (D) of copper. For example, when the segment coil 3 is a 3.00 mm×1.5 mm square flat wire made of tough pitch copper, and the molten pool 32 is irradiated with the laser light LB containing light of a near-infrared wavelength (1070 nm) of a spot diameter of 250 μm, and light of a visible light wavelength (450 nm) of a spot diameter of 900 μm, (A) is estimated as 102.0 W, (B) is estimated as 49.7 W, (C) is estimated as 47.3 W, and (D) is estimated as 12% with the near-infrared wavelength (1070 nm), and as 60% with the visible light wavelength (450 nm). When calculating the conditions from these values, by calculation formula: [supply energy density=(A+B+C)/D/spot area], the energy density of the laser light of the near-infrared wavelength (1070 nm) is 33.8 kW/cm², and the energy density of the laser light of the visible light wavelength (450 nm) is 1.41 kW/cm². Accordingly, from the viewpoint of forming the keyhole 321 in the molten pool 32 and effectively generating convection, the molten pool 32 is preferably irradiated with the laser light LB containing light of a near-infrared wavelength with an energy density of 33.8 kW/cm² or more, and light of a visible light wavelength with an energy density of 1.41 kW/cm² or more.

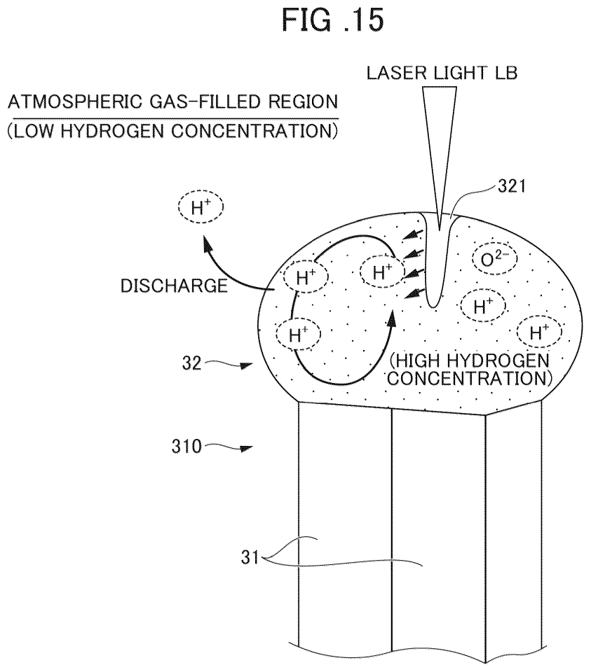

As shown by arrows in FIG. 15, the metal vapor pressure generated in the keyhole 321 acts on the region around the keyhole 321, and combined with stirring of the molten pool 32 by movement of the keyhole 321, generates convection in the molten pool 32. The region around the molten pool 32 is the atmospheric gas-filled region by the assist gas, which has a low hydrogen concentration, and therefore, by the convection generated in the molten pool 32, hydrogen (hydrogen ion [H⁺]) dissolved in the molten pool 32 is discharged to the atmospheric gas-filled region with a relatively low hydrogen concentration by the principle of diffusion. Consequently, discharge of hydrogen (hydrogen ion [H⁺]) dissolved in the molten pool 32 is further promoted.

The hydrogen concentration in the molten pool 32 is reduced by at least either one or preferably both of the IN side approach and the OUT side approach in the molten pool forming process as above. Thereafter, irradiation of the laser light LB to the molten pool 32 is ended, and the process proceeds to the weld bead forming process.

In the weld bead forming process, supply of the heat source to the molten pool 32 is stopped, and as the molten pool 32 changes from a liquid phase to a solid phase, the weld bead 33 is formed at the welding point 310. Since the hydrogen concentration in the molten pool 32 is reduced by the molten pool forming process, bond between oxygen (oxygen ion [O²⁻]) and hydrogen (hydrogen ion [H⁺]) in the process of the molten pool 32 changing from the liquid phase to the solid phase also decreases. Consequently, the weld bead 33 having high joining strength with hydrogen embrittlement suppressed is formed.

According to the conductor joining method according to the present embodiment, the following effects are exhibited. The conductor joining method includes the molten pool forming process of irradiating the welding point 310 of the coil end portions 31 and 31 that are conductors containing copper oxide with the laser light LB to form the molten pool 32 in which the welding point 310 is melted, and the weld bead forming process of solidifying the molten pool 32 to form the weld bead 33. In the molten pool forming process, irradiation of the laser light LB is performed so that the welding point 310 has a temperature higher than the melting point of copper and lower than the melting point of copper oxide to form the molten pool 32, and the irradiation position of the laser light LB to the molten pool 32 is changed to stir the molten pool 32. According to this, the coil end portions 31 and 31 that are conductors containing copper oxide can be joined by forming the weld bead 33 with generation of voids suppressed, by the simple method that only changes the irradiation position of the laser light LB to the molten pool 32.

In the present embodiment, in the molten pool forming process, the welding point 310 is irradiated with the laser light LB in the atmospheric gas-filled region. According to this, it is possible to reduce the amount of hydrogen that is dissolved into the molten pool 32 from the region around the welding point 310.

In the present embodiment, copper oxide is tough pitch copper equivalent to JIS C1100. According to this, the conductors are excellent in conductivity, and the amount of oxygen contained in the tough pitch copper is low, whereby it is possible to further suppress generation of voids in the weld bead 33.

In the present embodiment, the laser light LB contains the light of a near-infrared wavelength with the energy density of 33.8 kW/cm² or more, and the light of a visible light wavelength with the energy density of 1.41 kW/cm² or more. According to this, it is possible to effectively generate convection in the molten pool 32 by the keyhole 321 formed in the molten pool 32 by irradiation of the laser light LB. Accordingly, discharge of hydrogen dissolved into the molten pool 32 is promoted, and generation of voids in the weld bead 33 can be further suppressed.

In the present embodiment, the coil end portion 31 that is the conductor is the segment coil 3 that protrudes from the slot 22 of the stator core 2 in a rotating electric machine. According to this, it is possible to manufacture the rotating electric machine including the stator in which the conductor joining portions with high joining strength are formed by the simple method.

The laser welding apparatus 1 according to the present embodiment has the one laser irradiator 41, the one assist gas injector 51, and the one wall member 6, but is not limited to this. The laser welding apparatus 1 may have two or more sets each including the laser irradiator 41, the assist gas injector 51, and the wall member 6, and may be configured to simultaneously carry out laser welding to the plurality of coil end portion rows 30, with these sets disposed at predetermined intervals in the circumferential direction X of the stator core 2.

In the laser welding apparatus 1 according to the present embodiment, the wall member 6 is configured to sandwich the upper space S of the one coil end portion row 30 from both sides in the circumferential direction X by the pair of plate portions 61 and 61, but is not limited to this. The wall member 6 may be configured to sandwich the upper space S of the two or more adjacent coil end portion rows 30 from both sides in the circumferential direction X by the pair of plate portions 61 and 61 and may be configured to carry out laser welding with respect to the two or more coil end portion rows 30 at once.

The laser welding apparatus 1 according to the present embodiment is configured so as to rotationally move the stator core 2 by rotating the fixing jig 8 at the time of phase alignment of the wall member 6 and the coil end portion row 30, but is not limited to this. The laser welding apparatus 1 may be configured so that the laser irradiator 41, the assist gas injector 51, and the wall member 6 move along the circumferential direction X of the stator core 2 with respect to the stator core 2 immobile in position, or may be configured so that both of the stator core 2, and the laser irradiator 41, the assist gas injector 51 and the wall member 6 move in the opposite directions.

### EXPLANATION OF REFERENCE NUMERALS

2 stator core
22 slot
3 segment coil
31 coil end portion (conductor)
32 molten pool
33 weld bead
310 welding point
LB laser light

What is claimed is:

1. A conductor joining method, comprising:
forming a molten pool by irradiating a welding point of conductors containing copper oxide with laser light, thereby forming the molten pool in which the welding point is melted; and
solidifying the molten pool to form a weld bead,
wherein in formation of the molten pool, irradiation of the laser light is performed such that, by controlling at least one of laser output, irradiation time, and energy density, the welding point is heated to a temperature higher than a melting point of copper and lower than a melting point of the copper oxide to form the molten pool, and an irradiation position of the laser light is changed within the molten pool to stir the molten pool.

2. The conductor joining method according to claim 1, wherein in formation of the molten pool, the welding point is irradiated with the laser light in an atmospheric gas-filled region.

3. The conductor joining method according to claim 1, wherein the copper oxide is tough pitch copper equivalent to JIS C1100.

4. The conductor joining method according to claim 1, wherein the laser light contains light of a near-infrared wavelength with an energy density of 33.8 kW/cm² or more and light of a visible light wavelength with an energy density of 1.41 kW/cm² or more.

5. The conductor joining method according to claim 1, wherein the conductors are coils that protrude from a slot of a stator core of a rotating electric machine.
